(19) United States
(12) Patent Application Publication
(10) Pub. No.: US 2025/0096236 A1
(43) Pub. Date: Mar. 20, 2025

(54) CATHODE DESIGN AND COMPOSITION FOR LITHIUM-ION BATTERIES

(71) Applicant: Apple Inc., Cupertino, CA (US)

(72) Inventors: Hongli Dai, Los Altos, CA (US); Chi-kai Lin, San Jose, CA (US); James A. Gilbert, Bolingbrook, IL (US); Khalil Amine, Oakbrook, IL (US); Jihyeon Gim, Naperville, IL (US); John David Carter, Bolingbrook, IL (US); Arthur Jeremy Kropf, Westmont, IL (US); Yingying Xie, Woodridge, IL (US); Haiping Xu, Dekalb, IL (US)

(21) Appl. No.: 18/812,763

(22) Filed: Aug. 22, 2024

Related U.S. Application Data
(60) Provisional application No. 63/582,757, filed on Sep. 14, 2023.

(51) Int. Cl. H01M 4/36; H01M 4/02; H01M 4/131; H01M 4/525; H01M 4/62

(52) U.S. Cl. CPC H01M 4/364; H01M 4/131; H01M 4/366; H01M 4/525; H01M 4/62; H01M 2004/021; H01M 2004/028

(57) ABSTRACT

This disclosure relates generally to battery cells, and more particularly, cathode active materials for use in lithium-ion battery cells.

### PRIORITY

This patent application claims the benefit of U.S. Provisional Patent Application No. 63/582,757, entitled “CATHODE DESIGN AND COMPOSITION FOR LITHIUM-ION BATTERIES,” filed on Sep. 14, 2023, which is incorporated herein by reference in its entirety.

### U.S. GOVERNMENT LICENSE RIGHTS

This invention was made with U.S. government support under WFO Proposal No. 85C85. This invention was made under a CRADA Master Agreement No. 85C85 (P-1500801.01) Task Order No. 6, between Apple Inc. and Argonne National Laboratory operated for the United States Department of Energy. The U.S. government has certain rights in the invention.

### FIELD

This disclosure relates generally to battery cells, and more particularly, cathode active materials for use in lithium-ion battery cells.

### BACKGROUND

Li-ion batteries are widely used as the power sources in consumer electronics. Consumer electronics include Li-ion batteries which can deliver higher volumetric energy densities and sustain more discharge-charge cycles.

A battery life cycle can deteriorate due to degradation of the cathode active material structure. This is particularly true in high voltage applications. Cathode active material stability is one aspect of battery cell longevity.

### SUMMARY

In a first aspect, the disclosure is directed to a cathode active material including a plurality of lithium cobalt oxide (LCO) particles and nickel manganese cobalt (NMC) particles. The LCO particles are formed of a compound having the structure of Formula (I):

Li_{α}Co_{(1-w-x-y-z)}Al_{w}MgₓMn_{y}Ni_{z}O_{δ1} (I)
wherein 0.95≤α≤1.30 per mole fraction; 30%≤(1-w-x-y-z)≤60% by weight, 0%≤w≤1% by weight, 0%≤x≤0.2% by weight, 0.5%≤y≤10% by weight, and 3%δz≤26% by weight; and 1.98≤δ1≤2.04 per mole fraction. The plurality of LCO particles has 5 μm≤D50≤20 μm.

The plurality of NMC particles formed of a compound having the structure of Formula (II):

Li_{α}Ni₍₁₋ᵤ₋ᵥ₎MnᵤCoᵥO_{δ2} (II)
wherein 0.95≤α≤1.30 per mole fraction; 39%≤(1-u-v)≤51% by weight, 2%≤u≤20% by weight, 3%≤v≤20% by weight; and 1.98≤δ2≤2.04 per mole fraction. The plurality of NMC particles has 2 μm≤D50≤8 μm.

In a second aspect, the disclosure is directed to a battery cell. The battery cell can include a cathode having a cathode active material described herein disposed on a cathode current collector, and an anode having an anode active material disposed on an anode current collector. The anode is oriented towards the cathode such that the anode active material faces the cathode active material. A separator is disposed between the cathode active material and the anode active material. An electrolyte fluid is disposed between the cathode and anode.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a side view of a set of layers for a battery cell in accordance with an illustrative embodiment;

FIG. 3 depicts the energy retention as a function of cycle count for NMC particles as compared to LCO core particles and LCO biomodal particles, in accordance with illustrative embodiments;

FIG. 4 depicts an in operando XRD of cathode in a pouch cell of LCO operating at a voltage greater than 4.6V (vs. Li/Li+), in accordance with illustrative embodiments;

FIG. 5 depicts the phase transformation in a discontinuous crystal volume change in the LCO bimodal crystal structure, in accordance with illustrative embodiments;

FIG. 6 depicts a bimodal cell and a cell made with LCO filler only material are charged to increasing voltages at the same current, in accordance with illustrative embodiments;

FIG. 7 depicts single crystal NMC particles having increased O3 phase stability at high cell potentials, in accordance with illustrative embodiments;

FIG. 8 depicts the unit cell volume as a function of potential for NMC small particle filler materials, in accordance with illustrative embodiments;

FIG. 9A depicts the discharge capacity as a function of cycle count for battery cells having one of three cathode active materials, in accordance with illustrative embodiments;

FIG. 9B depicts the average cell voltage as a function of cycle count for battery cells having one of three cathode active materials, in accordance with illustrative embodiments;

FIG. 9C depicts discharge capacity as a function of cycle count at 45° C. and 4.52V upper cutoff voltage for battery cells having one of three cathode active materials, in accordance with illustrative embodiments;

FIG. 10 depicts the volumetric energy density (VED) of single crystal NMC (SC-NMC) materials, in accordance with illustrative embodiments; and

FIG. 11 depicts a coin cell showing normalized energy retention as a function of cycle count for a group of cathode active materials, in accordance with illustrative embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Commercial lithium-ion batteries with lithium cobalt oxide (LCO) cathode active materials often rely on a bimodal LCO particle-size distribution for the active cathode electrode to improve energy density of lithium-ion batteries. One drawback is that smaller “filler” particles, typically made of the same material as the larger “core” particles, are subject to greater electrochemical and crystallographic stress. The smaller size and greater surface area per unit volume of electrode induces preferential lithium extraction and insertion from the small particles. This results in an increased aging rate for the filler compared to the core.

The cathode active material includes a blended particle chemistry. The blended particle chemistry can achieve high energy particles with fast lithium exchange and diffusion kinetics, and have an extended operating potential. Non-blended LiCoO₂ or modified LiCoO₂ (LCO) cathode active materials alone can demonstrate a limit to high potential operation due to a discontinuous phase change at >4.50 V (e.g., a full cell having a graphite anode).

To increase the cycle stability of the electrode at elevated potentials, these particles are mixed with high-stability particles of nickel manganese cobalt (NMC) compounds. These particles can have greater crystallographic stability at high voltage, while can maintain equivalent energy density to the original material. Combining LCO and NMC compounds in a cathode active materials can increase cathode active material energy density and improve cycle retention of lithium ion batteries.

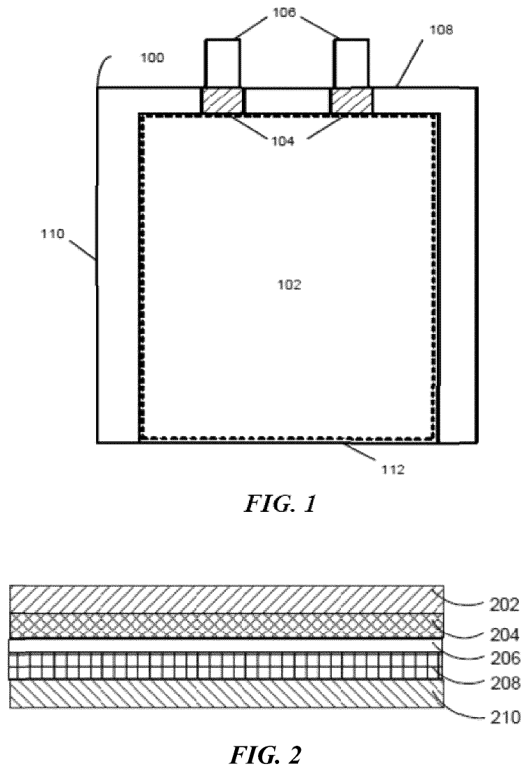

FIG. 1 presents a top-down view of a battery cell 100 in accordance with an illustrative embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between the cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

FIG. 2 presents a side view of a set of layers for a battery cell (e.g., the battery cell 100 of FIG. 1) in accordance with the disclosed embodiments. The set of layers may include a cathode current collector 202, a cathode active material 204, a separator 206, an anode active material 208, and an anode current collector 210. The cathode current collector 202 and the cathode active material 204 may form a cathode for the battery cell, and the anode current collector 210 and the anode active material 208 may form an anode for the battery cell. To create the battery cell, the set of layers may be stacked in a planar configuration, or stacked and then wrapped into a wound configuration.

As mentioned above, the cathode current collector 202 may be aluminum foil, the cathode active material 204 may be a lithium compound, the anode current collector 210 may be copper foil, the anode active material 208 may be carbon, and the separator 206 may include a conducting polymer electrolyte.

The cathode active materials described herein can be used in conjunction with any battery cells or components thereof known in the art. For example, in addition to wound battery cells, the layers may be stacked and/or used to form other types of battery cell structures, such as bi-cell structures. All such battery cell structures are known in the art.

The cathode current collector, cathode active material, anode current collector, anode active material, and separator may be any material known in the art. In some variations, the cathode current collector may be an aluminum foil, the anode current collector may be a copper foil.

The separator may include any separator material known in the art, such as a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (Pad). Other microporous polymer membranes or non-woven fabric mats are possible (e.g., gel polymer electrolytes).

In general, separators represent structures in a battery, such as interposed layers, that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

Blended cathode active materials including a plurality of LCO particles and a plurality of NMC particles having a bimodal particle size distribution are described. Larger LCO particles (core particles) having with high capacity and good electrical conductivity are combined with smaller NMC particles (filler particles) can provide for increased crystallographic and electrochemical stability at high potentials (>4.45 V) while keeping the same electrochemical energy.

LCO particles are formed of a compound having the structure of Formula (I):

Li_{α1}CO_{(1-w-x-y-z)}Al_{w}MgₓMn_{y}Ni_{z}O_{δ1} (I)
wherein 0.95≤α1≤1.30 per mole fraction; 30%≤(1-w-x-y-z)≤60% by weight, 0%≤w≤1% by weight, 0%≤x≤0.2% by weight, 0%≤y≤10% by weight, and 0%≤z≤26% by weight; and 1.98≤δ1≤2.04 per mole fraction. The compound of Formula (I) can include optional additional elements Ti, Zr, La, and Y each at a ≤0.2% by weight. The particles can include Ti, Zr, La, and Y each at a ≤0.2% by weight.

In some variations, the cathode active material can be under-lithiated. In one variation, 0.95≥α1. In another variation, 0.96≥α1. In another variation, 0.97≥α1. In another variation, 0.98≥α1. In another variation, 0.99≥α1. In another variation, 1.0≥α1. In one variation, 0.95≤α1. In another variation, 0.96≤α1. In another variation, 0.97≤α1. In another variation, 0.98≤α1. In another variation, 0.99≤α1.

In additional variations, 1.00≥α1. In another variation, 1.05≥α1. In another variation, 1.10≥α α1. In another variation, 1.15≥α1. In another variation, 1.20≥α1. In another variation, 1.25≥α1. In another variation, 1.30≥α1. In further additional variations, 1.25≥α1. In another variation, 1.20≥α1. In another variation, 1.15≥α1. In another variation, 1.10≥α1. In another variation, 1.05≥α1. In another variation, 1.00≥α1.

The value of α1 can have an upper limit, lower limit, or both. The upper and lower limits can be combined in any combination as disclosed herein.

In one variation, 30 wt %≤(1-w-x-y-z). In another variation, 35 wt %≤(1-w-x-y-z). In another variation, 40 wt %≤(1-w-x-y-z). In another variation, 45 wt %≤(1-w-x-y-z). In another variation, 50 wt %≤(1-w-x-y-z). In another variation, 55 wt %≤(1-w-x-y-z).

In another variation, (1-w-x-y-z)≤60 wt %. In another variation, (1-w-x-y-z)≤55 wt %. In another variation, (1-w-x-y-z)≤50 wt %. In another variation, (1-w-x-y-z)≤45 wt %. In another variation, (1-w-x-y-z)≤40 wt %. In another variation, (1-w-x-y-z)≤35 wt %.

The value of (1-w-x-y-z) can have an upper limit, lower limit, or both. The upper and lower limits can be combined in any combination as disclosed herein.

In one variation, 0 wt %≤w. In another variation, 0 wt %≤w. In another variation, 0.25 wt %≤w. In another variation, 0.50 wt %≤w. In another variation, 0.75 wt %≤w.

In another variation, w≤1.0 wt %. In another variation, w≤0.75 wt %. In another variation, w≤0.50 wt %. In another variation, 0.25 wt %≤w.

The value of w can have an upper limit, lower limit, or both. The upper and lower limits can be combined in any combination as disclosed herein.

In one variation, 0 wt %≤x. In another variation, 0 wt %≤x. In another variation, 0.0.01 wt %≤x. In another variation, 0.02 wt %≤x. In another variation, 0.03 wt %≤x. In another variation, 0.04 wt %≤x. In another variation, 0.05 wt %≤x. In another variation, 0.07 wt %≤x. In another variation, 0.09 wt %≤x. In another variation, 0.10 wt %≤x. In another variation, 0.12 wt %≤x. In another variation, 0.14 wt %≤x. In another variation, 0.16 wt %≤x. In another variation, 0.18 wt %≤x.

In another variation, x≤0.20 wt %. In another variation, x≤0.18 wt %. In another variation, x≤0.16 wt %. In another variation, 0.14 wt %≤x. In another variation, 0.12 wt %≤x. In another variation, 0.10 wt %≤x. In another variation, 0.09 wt %≤x. In another variation, 0.07 wt %≤x. In another variation, 0.05 wt %≤x. In another variation, 0.04 wt %≤x. In another variation, 0.03 wt %≤x. In another variation, 0.02 wt %≤x. In another variation, 0.01 wt %≤x.

The value of x can have an upper limit, lower limit, or both. The upper and lower limits can be combined in any combination as disclosed herein.

In one variation, 0 wt %≤y. In one variation, 0 wt %≤y. In one variation, 0.5 wt %≤y. In another variation, 0.5 wt %≤y. In another variation, 1.0 wt %≤y. In another variation, 2.0 wt %≤y. In another variation, 4.0 wt %≤y. In another variation, 6.0 wt %≤y. In another variation, 8.0 wt %≤y.

In another variation, y≤10.0 wt %. In another variation, y≤8.0 wt %. In another variation, y≤6.0 wt %. In another variation, 4.0 wt %≤y. In another variation, 2.0 wt %≤y. In another variation, 1.0 wt %≤y.

The value of y can have an upper limit, lower limit, or both. The upper and lower limits can be combined in any combination as disclosed herein.

In one variation, 0 wt %≤z. In one variation, 0 wt %≤z. In one variation, 1.0 wt %≤z. In one variation, 2.0 wt %≤z. In one variation, 3.0 wt %≤z. In another variation, 5.0 wt %≤z. In another variation, 10.0 wt %≤z. In another variation, 15.0 wt %≤z. In another variation, 20.0 wt %≤z. In another variation, 25.0 wt %≤z.

In another variation, z≤20.0 wt %. In another variation, z≤15.0 wt %. In another variation, z≤10.0 wt %. In another variation, z≤5.0 wt %. In another variation, z≤2.0 wt %. In another variation, z≤1.0 wt %.

The value of z can have an upper limit, lower limit, or both. The upper and lower limits can be combined in any combination as disclosed herein.

In some variations, 1.98≤δ1≤2.04. In some variations, 1.99≤δ1≤2.02. In some variations, δ1 is 2.00.

Alternatively, the LCO particles, compounds, and/or coatings are can be any described in published U.S. patent application Ser. Nos. 16/178,304, 16/802,347, 16/999,307, 16/999,328, 16/531,883, 16/529,545, 16/802,162, and 16/999,265, each of which are incorporated herein by reference in their entirety.

The D50 particle size distribution of the LCO particles can be 5 μm≤D50≤20 μm. In some variations, the D50 particle size distribution of the LCO particles can be at least 5 μm. In some variations, the D50 particle size distribution of the LCO particles can be at least 10 μm. In some variations, the D50 particle size distribution of the LCO particles can be at least 15 μm. In some variations, the D50 particle size distribution of the LCO particles can be less than or equal to 20 μm. In some variations, the D50 particle size distribution of the LCO particles can be less than or equal to 15 μm. In some variations, the D50 particle size distribution of the LCO particles can be less than or equal to 10 μm. The D50 particle size distribution can have a lower limit, and/or an upper limit, alternatively in any combination described herein.

The chemical composition of the smaller single crystal NMC particles are represented by formula (II):

Li_{α2}Ni₍₁₋ᵤ₋ᵥ₎MnᵤCoᵥO_{δ2} (II)
wherein 0.95≤α2≤1.30 per mole fraction; 39%≤(1-u-v)≤51% by weight, 2%≤u≤ 20% by weight, 3%≤v≤20% by weight; and 1.98≤δ2≤2.04 per mole fraction. The compound of Formula (II) can include Al, Mg, Ti, Zr, La, and Y, each at ≤1% by weight. The particles can include a coating having Al, Mg, Ti, Zr, La, and Y, each at ≤1% by weight.

In some variations, the cathode active material can be under-lithiated. In one variation, 0.95≥α2. In another variation, 0.96≥α2. In another variation, 0.97≥α2. In another variation, 0.98≥α2. In another variation, 0.99≤α2. In another variation, 1.0>α2. In one variation, 0.95≤α2. In another variation, 0.96≤α2. In another variation, 0.97≤α2. In another variation, 0.98≤α2. In another variation, 0.99≤α2.

In additional variations, 1.00≥α2. In another variation, 1.05≥α2. In another variation, 1.10≥α2. In another variation, 1.15≥α2. In another variation, 1.20≥α2. In another variation, 1.25≥α2. In another variation, 1.30≥α2. In further additional variations, 1.25≥α2. In another variation, 1.20≥α2. In another variation, 1.15≥α2. In another variation, 1.10≥α2. In another variation, 1.05≥α2. In another variation, 1.00≥α2.

The value of α2 can have an upper limit, lower limit, or both. The upper and lower limits can be combined in any combination as disclosed herein.

In some variations, 39 wt %≤(1-u-v). In another variation, 40 wt %≤(1-u-v). In another variation, 45 wt %≤(1-u-v). In another variation, 50 wt %≤(1-u-v).

In some variations, (1-u-v)≤51% by weight. In another variation, (1-u-v)≤50% by weight. In another variation, (1-u-v)≤45% by weight. In another variation, (1-u-v)≤40% by weight.

The value of (1-u-v) can have an upper limit, lower limit, or both. The upper and lower limits can be combined in any combination as disclosed herein.

In some variations, 2%≤u by weight. In some variations, 4%≤u by weight. In some variations, 6%≤u by weight. In some variations, 8%≤u by weight. In some variations, 10%≤u by weight. In some variations, 12%≤u by weight. In some variations, 14%≤u by weight. In some variations, 16%≤u by weight. In some variations, 18%≤u by weight.

In some variations, u≤20% by weight. In some variations, u≤18% by weight. In some variations, u≤16% by weight. In some variations, u≤14% by weight. In some variations, u≤ 12% by weight. In some variations, u≤10% by weight. In some variations, u≤8% by weight. In some variations, u≤6% by weight. In some variations, u≤4% by weight.

The value of u can have an upper limit, lower limit, or both. The upper and lower limits can be combined in any combination as disclosed herein.

In some variations, 3%≤v by weight. In some variations, 4%≤v by weight. In some variations, 6%≤v by weight. In some variations, 8%≤v by weight. In some variations, 10%≤v by weight. In some variations, 12%≤v by weight. In some variations, 14%≤v by weight. In some variations, 16%≤v by weight. In some variations, 18%≤v by weight.

In some variations, v≤20% by weight. In some variations, v≤18% by weight. In some variations, v≤16% by weight. In some variations, v≤14% by weight. In some variations, v≤12% by weight. In some variations, v≤10% by weight. In some variations, v≤8% by weight. In some variations, v≤6% by weight. In some variations, v≤4% by weight.

The value of v can have an upper limit, lower limit, or both. The upper and lower limits can be combined in any combination as disclosed herein.

In some variations, 1.98≤δ2≤2.04. In some variations, 1.99≤δ2≤2.02. In some variations, δ2 is 2.00.

The particle size distribution ranges between 2 μm≤D50≤8 μm. In some variations, the D50 particle size distribution of the NMC particles can be at least 2 μm. In some variations, the D50 particle size distribution of the NMC particles can be at least 4 μm. In some variations, the D50 particle size distribution of the NMC particles can be at least 6 μm. In some variations, the D50 particle size distribution of the NMC particles can be less than or equal to 8 μm. In some variations, the D50 particle size distribution of the NMC particles can be less than or equal to 6 μm. In some variations, the D50 particle size distribution of the NMC particles can be less than or equal to 4 μm. The D50 particle size distribution can have a lower limit, and/or an upper limit, alternatively in any combination described herein.

In some variations, NMC particles are from 15 wt %-50 wt % of the total particles. In some variations, the cathode active material is at least 15 wt % of NMC particles. In some variations, the cathode active material is at least 20 wt % of NMC particles. In some variations, the cathode active material is at least 25 wt % of NMC particles. In some variations, the cathode active material is at least 30 wt % of NMC particles. In some variations, the cathode active material is at least 35 wt % of NMC particles. In some variations, the cathode active material is at least 40 wt % of NMC particles. In some variations, the cathode active material is at least 45 wt % of NMC particles. In some variations, the cathode active material is at least 50 wt % of NMC particles. In some variations, the cathode active material is at least 55 wt % of NMC particles. In some variations, the cathode active material is at least 60 wt % of NMC particles. In some variations, the cathode active material is at least 65 wt % of NMC particles.

In some variations, the cathode active material is less than or equal to 70 wt % of NMC particles. In some variations, the cathode active material is less than or equal to 65 wt % of NMC particles. In some variations, the cathode active material is less than or equal to 60 wt % of NMC particles. In some variations, the cathode active material is less than or equal to 55 wt % of NMC particles. In some variations, the cathode active material is less than or equal to 50 wt % of NMC particles. In some variations, the cathode active material is less than or equal to 45 wt % of NMC particles. In some variations, the cathode active material is less than or equal to 40 wt % of NMC particles. In some variations, the cathode active material is less than or equal to 35 wt % of NMC particles. In some variations, the cathode active material is less than or equal to 30 wt % of NMC particles. In some variations, the cathode active material is less than or equal to 25 wt % of NMC particles. In some variations, the cathode active material is less than or equal to 20 wt % of NMC particles.

The combination of LCO and NMC particles can act synergistically to increase energy capacity and energy retention of the lithium-ion battery. As used herein, LCO-NMC cathode active materials refer to materials combining LCO materials of Formula (I) in particles as described herein, and NMC materials of Formula (II) in particles as described herein (also referred to as NMC filler particles). Filler particles generally refer more broadly to LCO or NMC particles with D50 particle sizes as described for Formula (II).

Cathode active materials that combine LCO and NMC particles (“blended LCO-NMC cathode active materials”) demonstrate comparable stability at 4.52 V compared to 4.50 V (vs. graphite anode) having only LCO cathode active materials. Cathode active materials include combined LCO and NMC particles demonstrate improved stability in operating potentials greater than 4.45V.

### EXAMPLES

The Examples are provided for illustration purposes only. These examples are not intended to constrain any embodiment disclosed herein to any application or theory of operation.

### Example 1

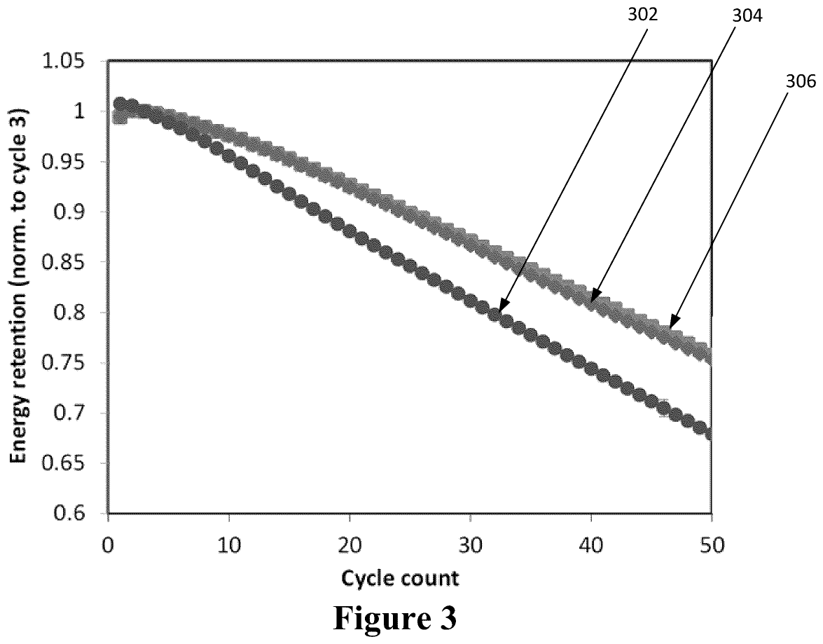

FIG. 3 depicts the energy retention as a function of cycle count for NMC particles 302 as compared to LCO core particles 304 and LCO biomodal particles 306. Coin cells (vs. Li/Li+) were cycled between 3.00 to 4.65 V at a rate of C/5 at 25° C. The volumetric cell discharge energy was normalized with respect to the third cycle of each coin cell to give the fraction of energy retention. In this example, an LCO and the bimodal mixture of core (large particle as described in Formula (II), and particles thereof) and filler (smaller particles as described in Formula (I), and particles thereof) show the same aging rate, whereas the NMC particles=ages faster for a given discharge current. The cathode active material includes 85 wt % LCO material. The bimodal compound has a slightly higher energy retention as a function of cycle count. The data show that NMC particles age faster than LCO or LCO bimodal electrodes in half-cell cycling.

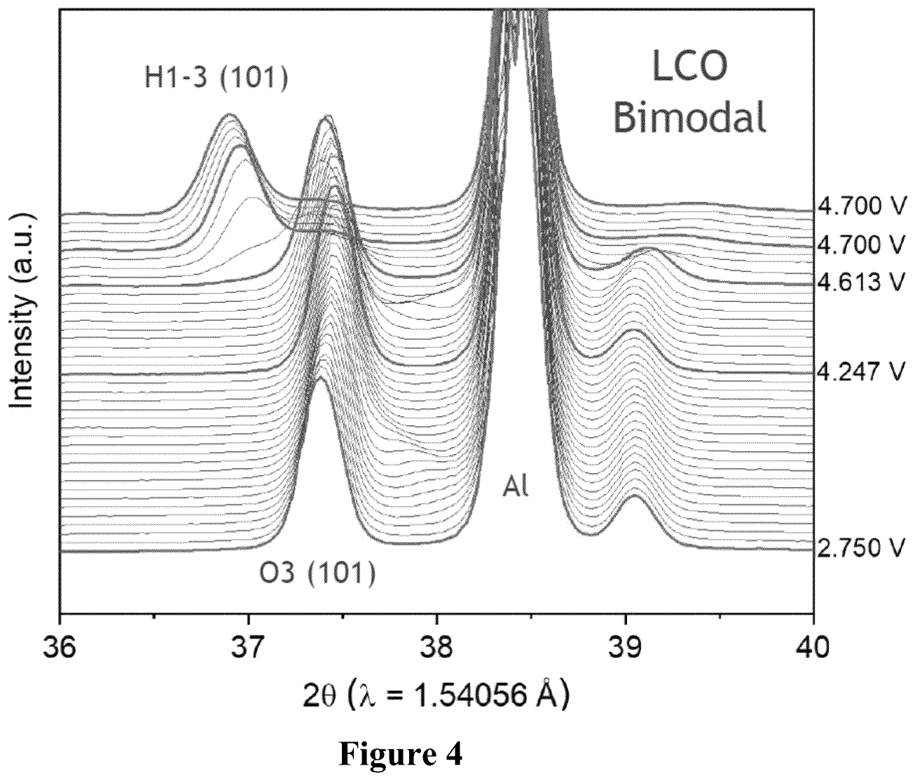

FIG. 4 depicts an in operando XRD of cathode in a pouch cell of LCO operating at a voltage greater than 4.6V (vs. Li/Li+). Without wishing to be held to any particular theory or mode of action, during battery charging as Li is extracted from the active cathode, the NMC particles lose lithium faster because of their smaller diameter, resulting in shorter diffusion lengths and increased surface area to volume ratio. As depicted in FIG. 4, at high states of charge (high potential>4.6V vs. Li/Li+), LiCoO₂ undergoes a phase transition from O3 to H1-3 as shown by the (101) XRD peak. Voltages higher than 4.5 V are avoided to reduce LCO breakdown.

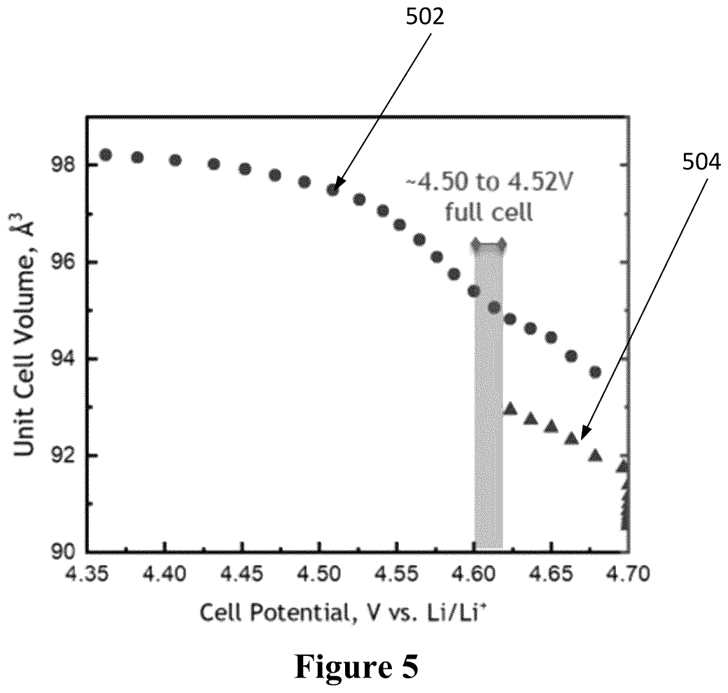

FIG. 5 depicts the phase transformation in a discontinuous crystal volume change in the LCO bimodal crystal structure. The volume change the O3 phase 502 to the H1-3 phase 504 creates a mismatch in the unit cell between the O3 phase 502 and H1-3 phase 504, which can facilitate defect formation leading to particle cracking and separation, and premature cell aging.

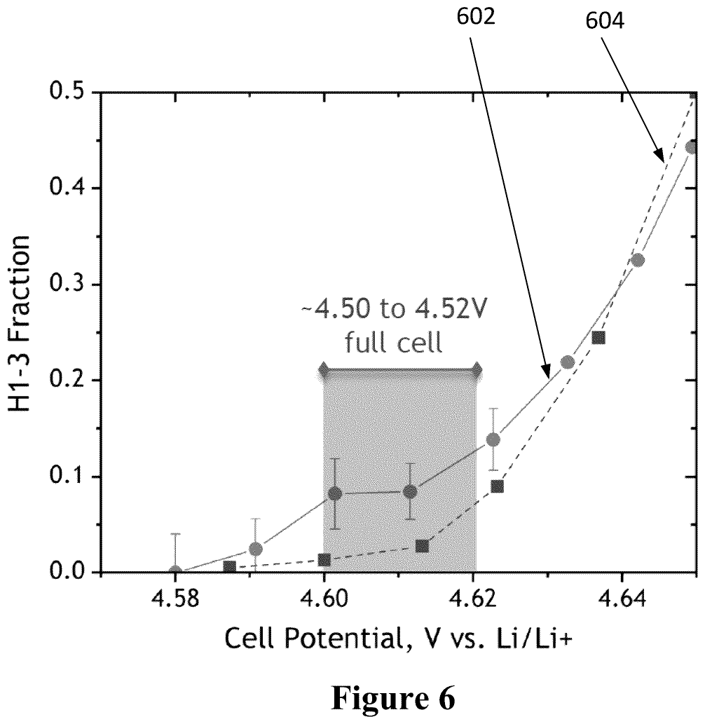

When the same type of LiCoO2 material is used as small particles and large particles, and higher potentials (4.50-4.52 V vs graphite) are applied to increase the overall energy of the battery cell, small particles more readily transform from the O3 phase to the H1-3 phase. As demonstrated in FIG. 6, a bimodal cell and a cell made with LCO filler (small particles) only material are charged to increasing voltages at the same current. The fraction of the H1-3 phase is monitored in-operando as the cell voltage increases. Between roughly 4.5 to 4.52 V (vs. graphite anode, or 4.6-4.62 V vs. Li/Li+ anode) the H1-3 fraction in the LCO small particle filler 602 increases rapidly beyond that of the bimodal LCO 604, demonstrating early phase transformation compared to the core LCO particles.

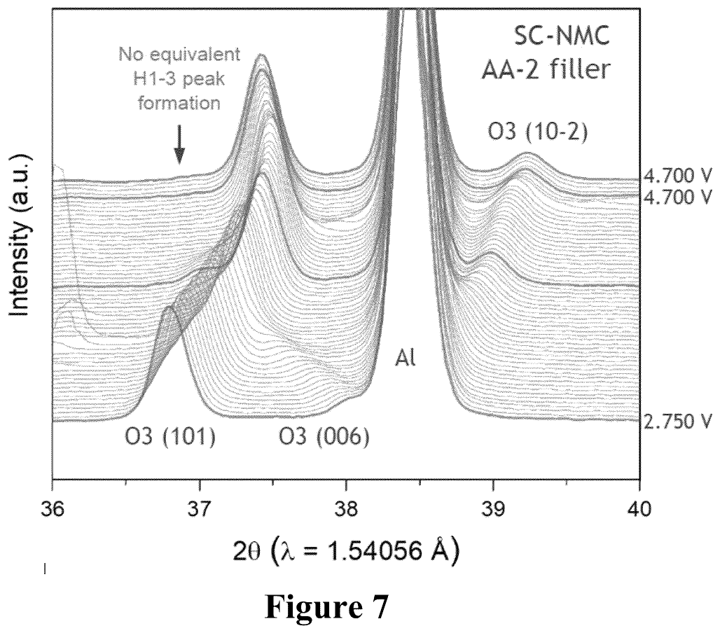

FIG. 7 depicts single crystal NMC particles having increased O3 phase stability at high cell potentials. The O3 phase at 2.75 V vs. Li/Li+ is continuous up to 4.7 V Li/Li+ indicating no formation of the H1-3 phase. In-operando XRD of cathode in lithium-ion cell indicates stable 03 phase up to 4.7 V.

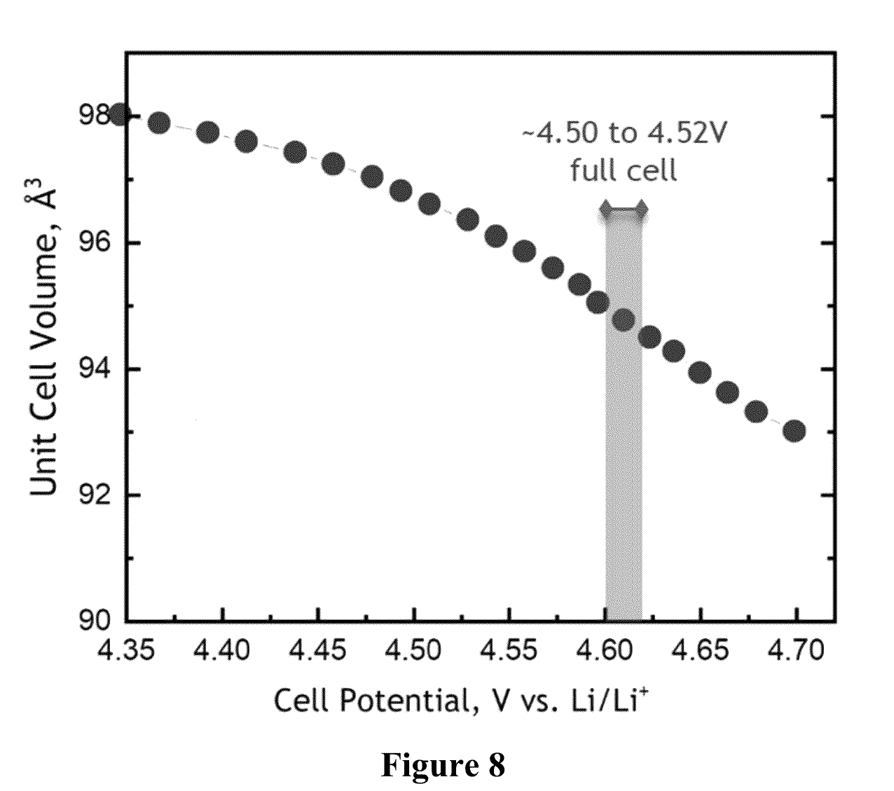

FIG. 8 depicts the unit cell volume as a function of potential for NMC small particle filler materials. No unit cell volume is observed, as the unit cell volume changes in a gradual and continuous curve up to 4.70 V Li/Li+, without discontinuities. The gradual and continuous change improves the lifetime of the electrode when blended as a small particle NMC filler material with LCO core particles.

An LCO-NMC bimodal cathode active material with LCO large particles and NMC small particle filler was tested in single layer full pouch cells operating at 25° C. and 4.52V upper cut-off voltage. Laminates made from the LCO-NMC bimodal mixtures were assembled with polyethylene-based separator sheets, graphite anodes, and a LiPF6/carbonate based electrolyte.

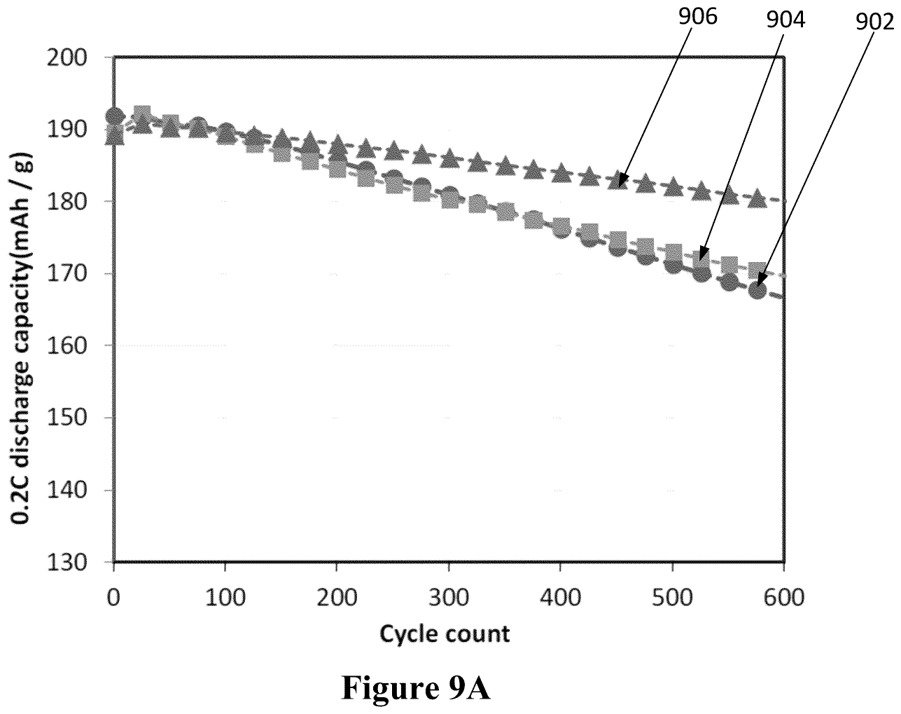

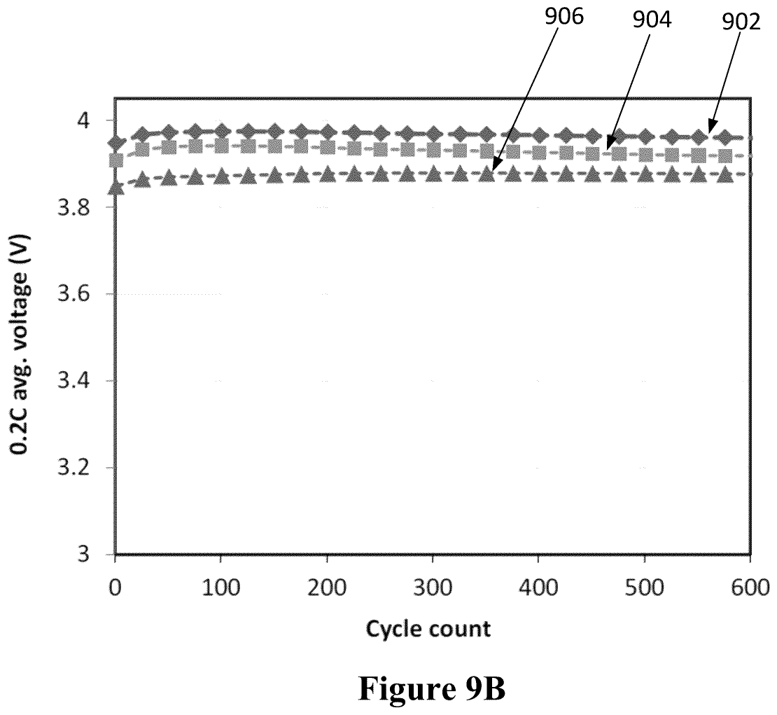

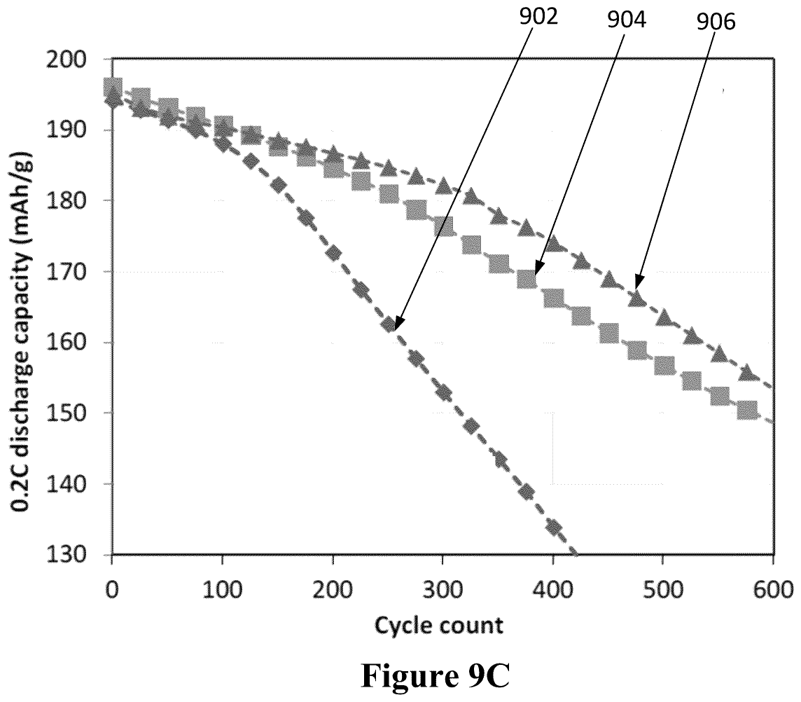

FIG. 9A depicts the discharge capacity as a function of cycle count for battery cells having one of three cathode active materials: a LCO-based bimodal cathode active material 902, a LCO-NMC bimodal cathode active material with 80 wt % LCO large particle and 20 wt % NMC small particles 904, and a LCO-NMC bimodal cathode active material with 50 wt % LCO large particle and 50 wt % NMC small particles 906. The demonstrates a slight improvement and then a >7% improvement in discharge cycle retention over 600 cycles with the 50:50 mixture. The discharge capacity retention is improved over the for the 50:50 LCO-NMC bimodal cathode active material.

FIG. 9B depicts the average cell voltage as a function of cycle count for battery cells having one of three cathode active materials: a LCO-based bimodal cathode active material 902, a LCO-NMC bimodal cathode active material with 80 wt % LCO large particle and 20 wt % NMC small particles 904, and a LCO-NMC bimodal cathode active material with 50 wt % LCO large particle and 50 wt % NMC small particles 906. The cell voltage remains stable for all compositions up to 600 cycles. The battery cell with a 50:50 LCO-NMC bimodal cathode active material had a 2.5% lower voltage than the LCO bimodal material.

FIG. 9C depicts discharge capacity as a function of cycle count at 45° C. and 4.52V upper cutoff voltage for battery cells having one of three cathode active materials: a LCO-based bimodal cathode active material 902, a LCO-NMC bimodal cathode active material with 80 wt % LCO large particle and 20 wt % NMC small particles 904, and a LCO-NMC bimodal cathode active material with 50 wt % LCO large particle and 50 wt % NMC small particles 906. At 45° C. cell operation, the initial cell capacities are increased to >195 mAh/g. The LCO bimodal rolls over at 125 cycles and drops below 130 mAh/g at 424 cycles. The 80:20 LCO-NMC bimodal cathode active material cycles longer, rolling over at 225 cycles and dropping below 150 mAh/g (−23%) at 600 cycles. The 50:50 LCO-NMC bimodal cathode active material cycles the longest, rolling over at 325 cycles and is >153 mAh/g (−21.5%) at 600 cycles. This demonstrates better high temperature stability at high cut-off voltage by including an NMC filler.

Table 1 provides a list cathode active material with improved discharge capacity and maintain cycle retention.

TABLE 1

| Cathode | Ni | Co | Mn | Coating | Coating |
|---|---|---|---|---|---|
| Material | (mol %) | (mol %) | (mol %) | (ppm by wt) | process |
| 1 | Doped LCO | | | Al 500/Ti 800/ | Dry |
| | | | | 300 Mg/470 F | |
| 2 | 65 | 25 | 10 | Al 500/Ti 800 | Dry |
| 3 | 65 | 25 | 10 | Al 170/Ti 380 | Wet |
| 4 | 65 | 30 | 5 | Al 320/Ti 900 | Wet |
| 5 | 65 | 30 | 5 | Al 170/Ti 380 | Wet |

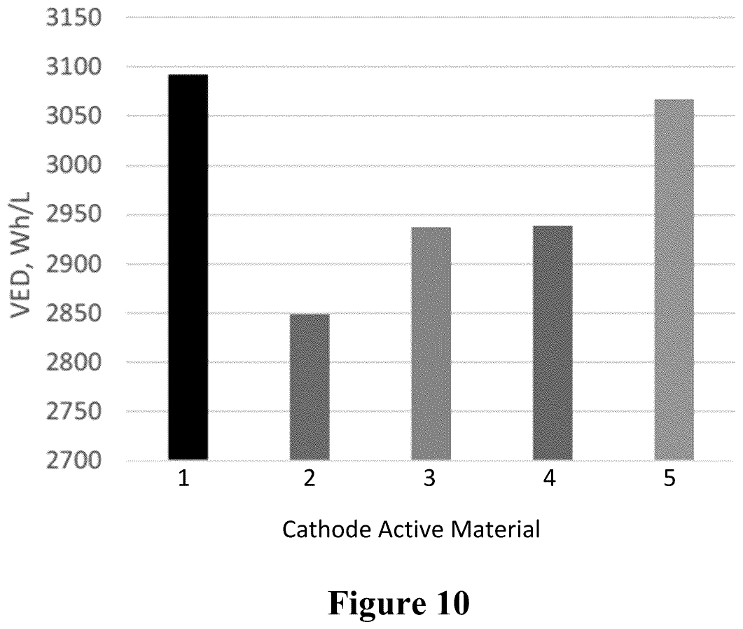

FIG. 10 depicts the volumetric energy density (VED) of cathode active materials. The cathode active materials 2 demonstrated increased cycle retention at the cost of reduced discharge capacity and voltage. Although Ni-rich materials typically demonstrate lower average voltages compared to Co-rich materials, the capacities were improved to overcome the cell voltage disadvantage.

The NMC filler can be selected based on the composition ratios and the particle coatings of Ni, Mn, and Co for more stability or higher capacity, depending on the battery cell performance requirements. If more Co is added to the composition, the total energy density can be increased. Or, if Mn is increased, the stability of the crystal structure is improved.

Particle coatings can increase the stability of the electrolyte and particle surface. Increasing A1 in the particle coating improved the energy retention at the cost of lower VED. The VED of cathode active materials 3 was improved over the baseline cathode active materials 2 using a wet coating process over industry coating method. The energy was further improved in cathode active materials 5 to nearly match the LCO filler by increasing the cobalt content from 25 to 30%, modifying the calcination procedure in a RHK furnace, and using a wet coating process for the Al/Ti coating.

In some variations, the coating includes La. In some variations, the coating includes Y. In some variations, the coating includes Zr. In some variations, the coating includes a combination of any two of La, Y, and Zr. In some variations, the coating includes La, Y, and Zr.

In some variations, the coating includes at least 100 ppm La. In some variations, the coating includes at least 200 ppm La. In some variations, the coating includes at least 300 ppm La. In some variations, the coating includes at least 400 ppm La. In some variations, the coating includes at least 500 ppm La. In some variations, the coating includes at least 200 ppm La. In some variations, the coating includes at least 600 ppm La. In some variations, the coating includes at least 700 ppm La. In some variations, the coating includes at least 200 ppm La. In some variations, the coating includes at least 800 ppm La. In some variations, the coating includes at least 900 ppm La.

In some variations, the coating includes less than or equal to 1000 ppm La. In some variations, the coating includes less than or equal to 900 ppm La. In some variations, the coating includes less than or equal to 800 ppm La. In some variations, the coating includes less than or equal to 700 ppm La. In some variations, the coating includes less than or equal to 600 ppm La. In some variations, the coating includes less than or equal to 500 ppm La. In some variations, the coating includes less than or equal to 400 ppm La. In some variations, the coating includes less than or equal to 300 ppm La. In some variations, the coating includes less than or equal to 200 ppm La.

The minimum and/or maximum quantity of La can be included in any combination described herein.

In some variations, the coating includes at least 100 ppm Y. In some variations, the coating includes at least 200 ppm Y. In some variations, the coating includes at least 300 ppm Y. In some variations, the coating includes at least 400 ppm Y. In some variations, the coating includes at least 500 ppm Y. In some variations, the coating includes at least 200 ppm Y. In some variations, the coating includes at least 600 ppm Y. In some variations, the coating includes at least 700 ppm Y. In some variations, the coating includes at least 200 ppm Y. In some variations, the coating includes at least 800 ppm Y. In some variations, the coating includes at least 900 ppm Y. In some variations, the coating includes at least 1000 ppm Y. In some variations, the coating includes at least 1100 ppm Y. In some variations, the coating includes at least 1200 ppm Y. In some variations, the coating includes at least 1300 ppm Y. In some variations, the coating includes at least 1400 ppm Y.

In some variations, the coating includes less than or equal to 1500 ppm Y. In some variations, the coating includes less than or equal to 1400 ppm Y. In some variations, the coating includes less than or equal to 1300 ppm Y. In some variations, the coating includes less than or equal to 1200 ppm Y. In some variations, the coating includes less than or equal to 1100 ppm Y. In some variations, the coating includes less than or equal to 1000 ppm Y. In some variations, the coating includes less than or equal to 900 ppm Y. In some variations, the coating includes less than or equal to 800 ppm Y. In some variations, the coating includes less than or equal to 700 ppm Y. In some variations, the coating includes less than or equal to 600 ppm Y. In some variations, the coating includes less than or equal to 500 ppm Y. In some variations, the coating includes less than or equal to 400 ppm Y. In some variations, the coating includes less than or equal to 300 ppm Y. In some variations, the coating includes less than or equal to 200 ppm Y.

The minimum and/or maximum quantity of Y can be included in any combination described herein.

In some variations, the coating includes at least 100 ppm Zr. In some variations, the coating includes at least 200 ppm Zr. In some variations, the coating includes at least 300 ppm Zr. In some variations, the coating includes at least 400 ppm Zr. In some variations, the coating includes at least 500 ppm Zr. In some variations, the coating includes at least 200 ppm Zr. In some variations, the coating includes at least 600 ppm Zr. In some variations, the coating includes at least 700 ppm Zr. In some variations, the coating includes at least 200 ppm Zr. In some variations, the coating includes at least 800 ppm Zr. In some variations, the coating includes at least 900 ppm Zr.

In some variations, the coating includes less than or equal to 1000 ppm Zr. In some variations, the coating includes less than or equal to 900 ppm Zr. In some variations, the coating includes less than or equal to 800 ppm Zr. In some variations, the coating includes less than or equal to 700 ppm Zr. In some variations, the coating includes less than or equal to 600 ppm Zr. In some variations, the coating includes less than or equal to 500 ppm Zr. In some variations, the coating includes less than or equal to 400 ppm Zr. In some variations, the coating includes less than or equal to 300 ppm Zr. In some variations, the coating includes less than or equal to 200 ppm Zr.

The minimum and/or maximum quantity of Zr can be included in any combination described herein.

The components of the coating, such as La, Y, and Zr, can be combined in any combination, amount, and maximum and/or minimum, as disclosed herein. By way of example and not limitation, La can be in an amount of at least 200-600 ppm, Y can be in an amount of 500-1100 ppm, and Zr can be in an amount of 200-600 ppm.

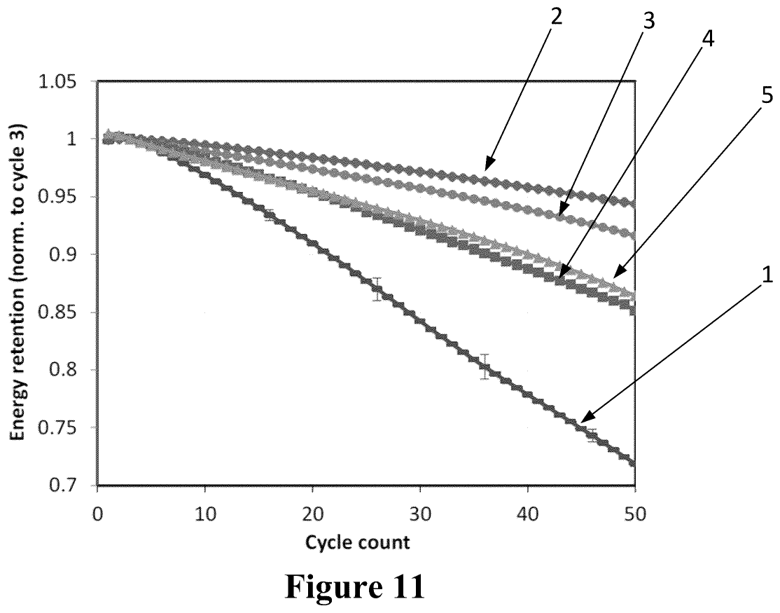

FIG. 11 depicts a coin cell showing normalized energy retention as a function of cycle count for cathode active materials of Table 1. Cathode active material 3 demonstrates the highest retention next to the cathode active material 2.

The cathode active materials described herein can be used in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A battery cell comprising:
a cathode comprising a cathode active material disposed on a cathode current collector, the cathode active material comprising
a plurality of LCO particles formed of a compound having the structure of Formula (I):
Li_{α1}CO_{(1-w-x-y-z)}Al_{w}MgₓMn_{y}Ni_{z}O_{δ1} (I)
wherein 0.95≤α1≤1.30 per mole fraction; 30%≤(1-w-x-y-z)≤60% by weight,
0%≤w≤1% by weight, 0%≤x≤0.2% by weight, 0%≤y≤10% by weight, and
0%≤z≤26% by weight; and 1.98≤δ1≤2.04 per mole fraction,
wherein the plurality of LCO particles has 5 μm≤D50≤20 μm; and
a plurality of NMC particles formed of a compound having the structure of Formula (II):
Li_{α2}Ni₍₁₋ᵤ₋ᵥ₎MnᵤCoᵥO_{δ2} (II)
wherein 0.95≤α2≤1.30 per mole fraction; 39%≤(1-u-v)≤51% by weight, 2%≤u≤20% by weight, 3%≤v≤20% by weight; and 1.98≤δ2≤2.04 per mole fraction,
wherein the plurality of NMC particles has 2 μm≤D50≤8 μm;
an anode comprising an anode active material disposed on an anode current collector, the anode oriented towards the cathode such that the anode active material faces the cathode active material; and
a separator disposed between the cathode active material and the anode active material.

2. The battery cell of claim 1, wherein the plurality of NMC particles are from 15 wt %-70 wt % of the total particles.

3. The battery cell of claim 1, wherein the plurality of NMC particles are from 15 wt %-50 wt % of the total particles.

4. The battery cell of claim 1, wherein the plurality of NMC particles are from 40 wt %-60 wt % of the total particles.

5. The battery cell of claim 1, wherein the plurality of NMC particles are from 45 wt %-55 wt % of the total particles.

6. The battery cell of claim 1, wherein the D50 of the plurality of LCO particles is at least 10 μm.

7. The battery cell of claim 1, wherein the D50 of the plurality of LCO particles is at least 15 μm.

8. The battery cell of claim 1, wherein the D50 of the plurality of LCO particles is less than or equal to 15 μm.

9. The battery cell of claim 1, wherein the D50 of the plurality of LCO particles is less than or equal to 10 μm.

10. The battery cell of claim 1, wherein the D50 of the plurality of NMC particles is at least 4 μm.

11. The battery cell of claim 1, wherein the D50 of the plurality of NMC particles is at least 6 μm.

12. The battery cell of claim 1, wherein the D50 of the plurality of NMC particles is less than or equal to 6 μm.

13. The battery cell of claim 1, wherein the D50 of the plurality of NMC particles is less than or equal to 4 μm.

14. The battery cell of claim 1, wherein each of the plurality of particles comprises a coating comprising La.

15. The battery cell of claim 1, wherein each of the plurality of particles comprises a coating comprising Y.

16. The battery cell of claim 1, wherein each of the plurality of particles comprises a coating comprising Zr.

17. The battery cell of claim 1, comprising an electrolyte fluid.

18. The battery cell of claim 1, wherein the battery is configured to operate at 4.45 V cutoff voltage.

19. The battery cell of claim 1, wherein the battery is configured to operate at 4.50 V cutoff voltage.

20. The battery cell of claim 1, wherein the battery is configured to operate at 4.52 V cutoff voltage.
